(19) United States
(12) Patent Application Publication
(10) Pub. No.: US 2025/0002104 A1
(43) Pub. Date: Jan. 2, 2025

(54) BICYCLE SUPPORT FOR TRAVEL PACK

(71) Applicant: Adam W. Keen, Valparaiso, IN (US)

(72) Inventor: Adam W. Keen, Valparaiso, IN (US)

(21) Appl. No.: 18/706,080

(22) PCT Filed: Nov. 1, 2022
(86) PCT No.: PCT/US2022/048611

§ 371 Date: Apr. 30, 2024

Related U.S. Application Data
(60) Provisional application No. 63/335,846, filed on Apr. 28, 2022.
(60) Provisional application No. 63/274,340, filed on Nov. 1, 2021.

(51) Int. Cl. B62J 7/04; B62J 11/00

(52) U.S. Cl. CPC B62J 7/04; B62J 11/00

(57) ABSTRACT

An attachment for a bicycle is provided to facilitate travel with a pack, such as a backpack or messenger bag, without requiring the entirety of the load to be carried by the body of the user. The attachment is capable of being coupled to bicycles across different types and sizes and is further capable of being adjusted to fit the needs of individual users. Additionally, the bicycle attachment may provide a convenient way to attach other accessories to the bicycle.

### FIELD OF THE DISCLOSURE

The present disclosure relates to a support for use with a bicycle and, more particularly, relates to a support configured to facilitate the carrying of packs, such as messenger bags or backpacks, during trips while alleviating the strain on the user's body by assuming at least a portion of the weight of the corresponding pack.

### BACKGROUND OF THE DISCLOSURE

Carrying luggage with a bicycle can be onerous and bulky for a bicyclist. While riding with a rider-worn bag, the weight in bags can shift, inconveniencing the bicyclist and increasing the difficulty of the ride. Additionally, rider-worn bags can fatigue the bicyclist. Attaching bags to the bicycle can offer a better solution than a user carried bag. However, known bicycle bag attachments can be bulky, inconvenient, limiting, or allow the bag to get in the way of the rider during the trip.

### SUMMARY OF THE DISCLOSURE

In exemplary embodiments of the present disclosure an attachment for a bicycle is provided to facilitate travel with a pack, such as a backpack or messenger bag, without requiring the entirety of the load to be carried by the body of the user. The attachment is capable of being coupled to bicycles across different types and sizes and is further capable of being adjusted to fit the needs of individual users. Additionally, the bicycle attachment may also provide a convenient way to attach other accessories to the bicycle.

In a first aspect of the disclosure, a bicycle attachment is disclosed, the attachment comprising: a support system, comprising: at least two support beams; and a shelf pivotably supported by the at least two support beams.

The at least two support beams of the bicycle attachment may further include a first lower support beam and a second lower support beam coupled to the first lower support beam. The first lower support beam and second lower support beam may be coupled to a lower rear frame of a bicycle so that the first and second lower support beams straddle a rear tire of the bicycle to form a triangle shape defining an apex. The shelf may be positioned above the apex. The first lower support beam and the second lower support beam may be sewed in relation to each other so that the first lower support beam couples to the lower rear frame close to a bicycle seat and the second lower support beam couples to the lower rear frame closer to the rear tire of the bicycle.

The lower rear frame of the bicycle may include a first lower rear frame and a second lower rear frame, the first lower rear frame and the second lower rear frame extending from a convergence point near a bicycle seat toward the rear tire. The first lower rear frame may extend on one side of the rear tire and the second lower rear frame extends on the other side of the rear tire. In one example, the first lower support beam is coupled to the lower rear frame with a collar, the collar configured to removably clamp both the first lower rear frame and the second lower rear frame close to the convergence point of the first lower rear frame and the second lower rear frame. In another example, the at least two lower support beams are configured to receive a corresponding inner support beam in a telescoping configuration so that the inner support beam moves within the corresponding at least two lower support beams, making a height of the support system adjustable.

In another aspect of the disclosure, a modular attachment for supporting a pack may be disclosed, the modular attachment comprising: a rail; a first lower support beam coupled to the rail; a second lower support beam coupled to the rail opposite the first lower support beam; a shelf coupled to the rail. The rail may be configured to pivot upward or downward to position the shelf. The rail may further include a first rail that corresponds with the first lower support beam and a second rail that corresponds with the second lower support beam. The first rail further may include a mechanical fastener to lock a pivoting position of the first rail relative to the first lower support beam and the second rail further includes a mechanical fastener to lock a pivoting position of the second rail relative to the second lower support beam. The first rail may extend from its corresponding first lower support beam curving toward the second rail to from an L-shape and the second rail extends from its corresponding second lower support beam curving toward the first rail to from an L-shape. In another example of this aspect, the modular attachment further comprises a cross rail that couples to the first rail and the second rail so that a constant distance is maintained between the first rail and the second rail. The cross rail has a sliding relationship with the first rail and the second rail so that the first rail and the second rail may slide laterally.

In another aspect of the modular attachment for supporting a pack, the modular attachment comprises: a first lower support beam; a second lower support beam movably coupled to the first lower support beam so that an angle is defined therebetween, the first lower support beam and the second lower support beam defining a triangular shape with an apex; and a shelf pivotably coupled to the apex. The first lower support beam further comprises a first inner beam and a first outer beam. The first inner beam and the first outer beam may define a telescoping relationship so that a height of the first lower support beam is adjustable. The fist lower support beam may be coupled to a lower rear frame of a lower rear frame of a bicycle.

The second lower support beam further comprises a second inner beam and a second outer beam. The second inner beam and the second outer beam may define a telescoping relationship so that a height of the second lower support beam is adjustable. The second lower support beam may be coupled to the lower rear frame of a bicycle. In an example, the shelf is configured to tilt by raising and lowering the first inner support beam and the second inner support beam. In a further aspect of this embodiment, the shelf is configured to tilt by positioning the first lower support beam and the second lower support beam relative to the lower rear frame of the bicycle.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The foregoing aspects and many additional features of the present invention and accompanying methods will become more readily appreciated and become better understood by reference to the following detailed description when taken in conjunction with the accompanying figures. The detailed description of the drawings particularly refers to the accompanying figures in which:

FIG. 1 illustrates a pack support for use with a bicycle to support a pack utilized by a user to travel on a bicycle;

FIG. 2 illustrates the pack support of FIG. 1 in use with a user and a pack; and

FIG. 3 is a schematic illustration of another embodiment of a pack support, the pack support including telescoping support beams to allow for modularity and application of the pack support between bicycles of differing shapes and sizes and a flexible strap positioned between the corresponding bicycle and the telescoping support beams;

FIG. 4 is a schematic illustration of the embodiment of FIG. 3, including a rigid lateral support beam rather than a flexible strap;

FIG. 5 illustrates another embodiment of a pack support including telescoping support beams, an adjustable lateral support beam, and an adjustable shelf for supporting a pack;

FIG. 6 illustrates a frame of the pack support of FIG. 5;

FIG. 7 illustrates the adjustable lateral support beam of the pack support of FIG. 5; and

FIG. 8 illustrates a shelf of the pack support of FIG. 5.

FIG. 9 illustrates another embodiment of a pack support including two telescoping support beams, and an adjustable shelf for supporting a pack;

FIG. 10 illustrates an embodiment of a collar that couples a lower support beam;

FIG. 11 illustrates a blown apart view of the collar in FIG. 10;

FIG. 12 illustrates a shelf of the pack support of FIG. 9;

FIG. 13a illustrates an embodiment of a pack support including a horizontal support beam and a vertical support beam arranged in an L-shape, and a shelf for supporting a pack;

FIG. 13b illustrates an embodiment of a pack support including a curved support beam arranged in an L-shape, and a shelf for supporting a pack

FIG. 13c illustrates an embodiment of a pack support including a horizontal support beam and a vertical support beam arranged in an L-shape, and a shelf for supporting a pack;

FIG. 14 illustrates a shelf of the pack support of FIG. 13a-c; and

FIG. 15 illustrates a hose clamp for couplings in FIG. 9.

FIG. 16a illustrates an embodiment of a pack support including a utility pole and a vertical support beam arranged in an L-shape, and a shelf for supporting a pack.

FIG. 16b illustrates a utility pole for the pack support in FIG. 16a.

FIG. 17 illustrates an L-shaped support bar for a Rack that couples to the pack support in FIG. 16a.

FIG. 18 illustrates a support platform for the Rack in FIG. 17.

FIG. 19 illustrates a curved side support for the Rack in FIG. 17.

FIG. 20 illustrates a Hanger coupled to the pack support in FIGS. 16a-b.

FIG. 21 illustrates the vertical support beams, back support surface, horizontal rack, and prongs of the Hanger in FIG. 20.

Corresponding reference characters indicate corresponding parts throughout the several views. Although the drawings represent embodiments of various features and components according to the present disclosure, the drawings are not necessarily to scale, and certain figures may be exaggerated in order to better illustrate and explain the present disclosure.

### DETAILED DESCRIPTION OF THE DRAWINGS

For the purposes of promoting an understanding of the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

The terms “couples”, “coupled”, “coupler” and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

In some instances throughout this disclosure and in the claims, numeric terminology, such as first, second, third, fourth, etc., is used in reference to various components of features. Such use is not intended to denote an ordering of the components or features. Rather, numeric terminology is used to assist the reader in identifying the components or features being referenced and should not be narrowly interpreted as providing a specific order of components or features.

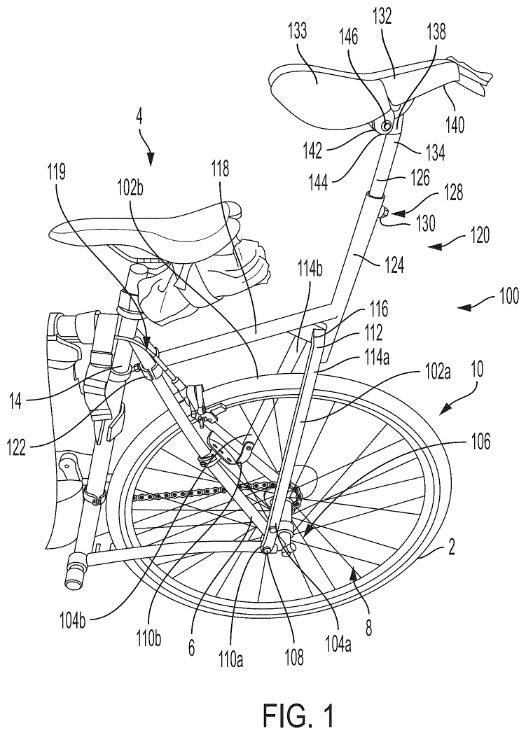

Referring to FIG. 1, a pack support 100 is illustrated. The pack support 100 is comprised of a number of support beams. A pair of lower support beams 102 straddle a rear or back tire 2 of a bicycle 4, forming a triangle-type shape. A first lower support beam 102a extends along a radius of the back tire 2 on a first side 8 of the back tire 2 so that a lower portion 104a of the first lower support beam 102a is configured to couple to the lower rear frame 6 of the bicycle 4 at a first lower coupling point 110a as described further herein. A second lower support beam 102b extends along the radius of the back tire 2 of a second side 10 of the back tire 2 so that a lower portion 104b of the second lower support beam 102b is configured to couple to the lower rear frame 6 of the bicycle 4 at a second lower coupling point 110b as described further herein. For example, the lower portion 104 of the lower support beams 102 may be coupled to the lower rear frame 6 via, for example, a bracket 106, such as a U-bracket or a clamp, and at least one mechanical fastener 108, such as a bolt, a screw, or another suitable fastener. Illustratively, lower support beams 102 may be removably coupled to lower rear frame 6 at or adjacent the axis of rotation of rear tire 2.

The first lower support beam 102a and the second lower support beam 102b extend from their respective coupling points 110a and 110b to and beyond an outer perimeter 12 of back tire 2 to be joined at apex 112. As illustrated in FIG. 1, an upper portion 114 of each of the lower support beams 102 is fixedly coupled to a center bracket 116, which serves to couple the lower support beams 102 to a lateral support beam 118 and/or an upper support beam 120 as described further herein. The lower support beams 102 may be coupled to center bracket 116 via welding, overmolding, single-piece manufacturing, or other suitable coupling methods. In other embodiments, the lower support beams 102 are removably or otherwise coupled to the center bracket 116 or other components of the upper portion of the pack support 100 via other methods, such as mechanical fasteners, adhesive, or other suitable coupling methods. As illustrated, the center bracket 116 is fixedly coupled to a lateral support beam 118, for example, by welding, overmolding, single-piece manufacturing, or other suitable coupling methods. In other embodiments, the lateral support beam 118 may be removably or otherwise coupled to the center bracket 116 via other methods, such as mechanical fasteners, adhesive, or other suitable coupling methods.

The center bracket 116 is further fixedly coupled to upper support beam 120 via, for example, welding, overmolding, single-piece manufacturing, or other suitable coupling methods. In other embodiments, the upper support beam 120 may be removably or otherwise coupled to the center bracket 116 via other methods, such as mechanical fasteners, adhesive, or other suitable coupling methods. As shown, the upper support beam 120 may also be coupled to the lateral support beam 118 via any of the coupling methods described above, so that the lateral support beam 118 extends from the upper support beam 120 to an upper rear frame 14 of the bicycle 4, where the lateral support beam 118 couples to the upper rear frame 14 of the bicycle 4 via, for example, a bracket 122, such as a U-bracket or a clamp, at a coupling point 119. The lateral support beam 118 may further utilize a fastener to couple to the upper rear frame 14 of the bicycle 4.

The upper support beam 120 includes an outer beam 124 and an inner beam 126, wherein the inner beam 126 and the outer beam 124 have a telescoping relationship so that inner beam 126 is received within outer beam 124. The outer beam 124 includes at least one opening 128 and, in some embodiments, a plurality of openings 128 configured to selectively receive a detent or pin 130 of the inner beam 126 to maintain a height or position of upper support beam 120. The telescoping relationship between inner beam 126 and outer beam 124 and the selective coupling relationship between the opening(s) 128 and the pin 130 allow for manual adjustment of the overall height of the upper support beam 120.

A shelf 132 is pivotably coupled to a top end 134 of the inner beam 126 so that the shelf 132 can tilt forward and backward relative to the upper support beams 120, or, in other words, tilt so that a top surface 133 of the shelf 132 faces toward or away from bicycle 4. A receiving stem 138 extends from a bottom surface 140 of the shelf 132 to receive a portion of the inner beam 126. A first paired protrusion 142 extends laterally from the inner beam 126, wherein the first paired protrusion 142 includes a first semi-circular protrusion defining a first through hole and a second semi-circular protrusion defining a second through hole. The first semi-circular protrusion is positioned closer to the first side 8 of the back tire 2, while the second semi-circular protrusion is positioned closer to the second side 10 of the back tire 2. A corresponding second paired protrusion 144 extends laterally from the receiving stem 138, wherein the second paired protrusion 144 includes a third semi-circular protrusion defining a third through hole and a fourth semi-circular protrusion defining a fourth through hole. The third semi-circular protrusion is positioned closer to the first side 8 of the back tire 2, while the fourth semi-circular protrusion is positioned closer to the second side 10 of the back tire 2. The second paired protrusion 144 defines a space between the third semi-circular protrusion and the fourth semi-circular protrusion that allows first paired protrusion 142 to be received within the space so that the first semi-circular protrusion is positioned adjacent to the third semi-circular protrusion and the second semi-circular protrusion is positioned adjacent to the fourth semi-circular protrusion. When the second paired protrusion 144 has received the first paired protrusion 142, the first through hole, second through hole, third through hole, and fourth through hole are configured to align and receive pivot rod 146.

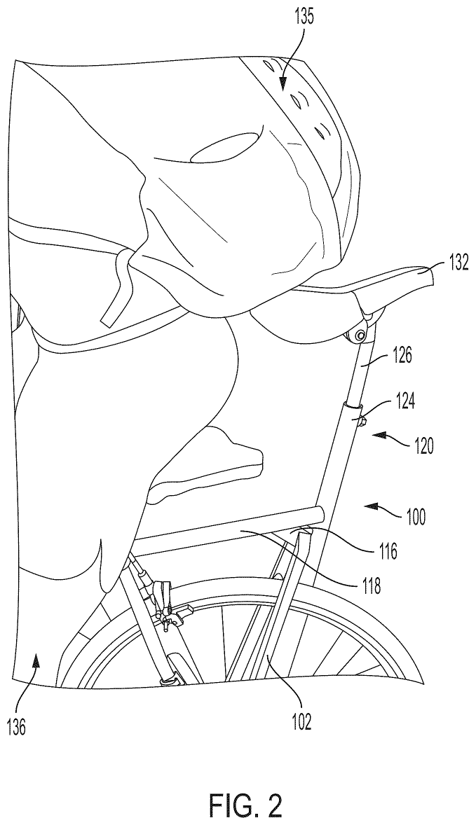

The alignment of the paired protrusions 142, 144 and receiving of the pivot rod 146 allows for the tilting of the shelf 132 relative to the bicycle 4, while the receiving of the inner beam 126 within the receiving stem 138 maintains alignment of the shelf 132 with the upper support beam 120 to prevent unwanted movement of the shelf 132. The shelf 132 may be padded to better support and protect a pack 135 (FIG. 2). For example, when the bicycle 4 is ridden over rough terrain, the padded shelf 132 may help mitigate damage to the pack 135 which could be caused by jostling or turbulence experienced by the bicycle 4 on such terrain. The tilting characteristic of the shelf 132 and the adjustable height of the upper support beam 120 allows the user to position the shelf 132 appropriately to best support the pack 135 (FIG. 2) to facilitate the carrying of the pack 135 by the rider 136 (FIG. 2).

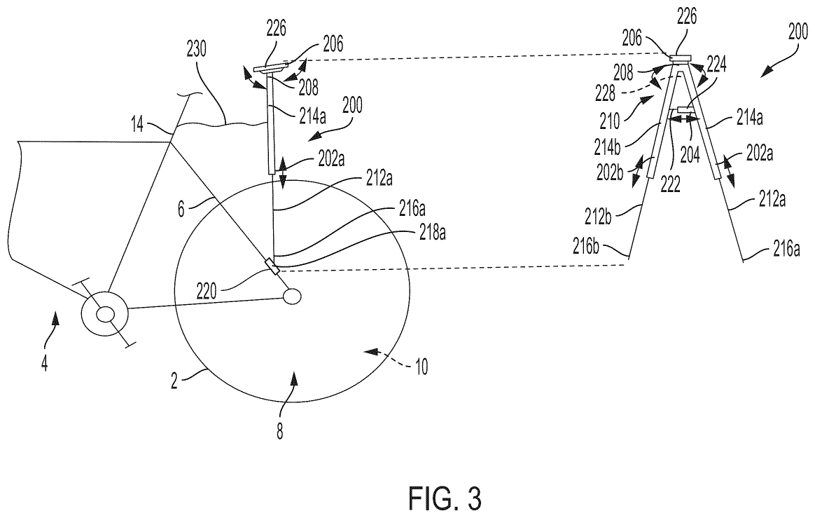

Now referring to FIG. 3, another embodiment of a pack support 200 is illustrated. The pack support 200 includes an A-frame 210, or a triangular shape, having a pair of legged support beams 202, a cross support beam 204 extending between each of the legged support beams 202, and a shelf 206 coupled to the legged support beams 202 at an apex 208 of the A-frame 210. Each of the legged support beams 202 include an inner beam 212 and an outer beam 214, wherein the inner beam 212 is received within the outer beam 214 to form a telescoping relationship so that the pack support 200 has an adjustable height.

A first legged support beam 202a extends along a first side 8 of a back tire 2 of a bicycle 4 so that a lower portion 216a of the inner beam 212a is configured to couple to the lower rear frame 6 of the bicycle 4 at a first lower coupling point 218a as described further herein. A second legged support beam 202b extends along a second side 10 of the back tire 2 of the bicycle 4 so that a lower portion 216b of the inner beam 212b is configured to couple to the lower rear frame 6 of the bicycle 4 at a second lower coupling point (not shown). The lower portions 216 of each corresponding inner beams 212 may be coupled to the lower rear frame 6 via, for example, a collar 220 fitted around the lower rear frame 6 that can be selectively positioned along a length of the lower rear frame 6 and then tightened to form an interference fit with the lower rear frame 6. The collar 220 may be positioned along the lower rear frame 6 as desired to appropriately position the shelf 206 as described further herein. The collar 220 may require mechanical fasteners or otherwise include a snap collar or quick-release collar. In some embodiments, the collar 220 may have a durable non-slip lining, such as rubber or another friction polymer, to protect the lower rear frame 6 of the bicycle 4 and facilitate secure coupling of the legged support beams 202 to the lower rear frame 6 of the bicycle 4.

The cross support beam 204 includes an inner beam 222 and an outer beam 224 so that inner beam 222 and outer beam 224 form a telescoping relationship. The telescoping relationship of the inner beam 222 and the outer beam 224 allow a user to change the distance between the first legged support beam 202a and the second legged support beam 202b, wherein the distance between the first legged support beam 202a and the second legged support beam 202b change about the apex 208 of the A-frame 210. In other words, an angle 228 between the first legged support beam 202a and the second legged support beam 202b is adjustable, in turn altering the distance between the first legged support beam 202a and the second legged support beam 202b along the length of the A-frame 210.

A strap 230 extends between the cross support beam 204 and an upper rear frame 14 of the bicycle 4 to facilitate control of the distance between the cross support beam 204 and the upper rear frame 14 of the bicycle 4. The strap 230 facilitates a flexible connection between the A-frame 210 and the upper rear frame 14 of the bicycle 4 to allow flexibility of movement between the A-frame 210 and the bicycle 4 while maintaining a connection between the A-frame 210 and the upper rear frame 14 of the bicycle 4 and further maintaining the A-frame 210 in a generally upright position. Such a connection allows for movement of the A-frame 210 when required, for example, when the bicycle is ridden over rough or otherwise unsmooth terrain. The flexible connection allows for such movement to mitigate any damage or breakage that may otherwise occur in such a situation should a rigid connection be used.

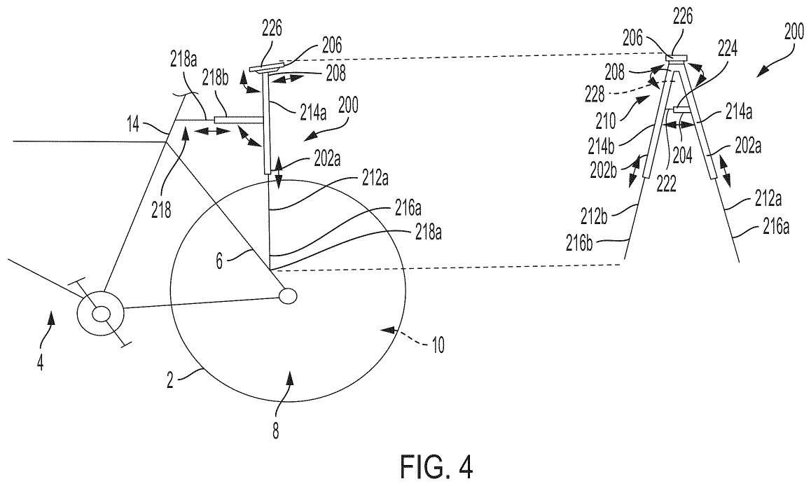

In other embodiments, as shown in FIG. 4, the pack support 200 may include a lateral support beam 218 rather than a strap 230. Like strap 230, the lateral support beam 218 extends between the cross support beam 204 and the upper rear frame 14 of the bicycle 4 to facilitate control of distance between the cross support beam 204 and the upper rear frame 14 of the bicycle 4. The lateral support beam 218 includes an inner beam 218a and an outer beam 218b so that the inner beam 218a and the outer beam 218b form a telescoping relationship. The telescoping relationship of the inner beam 218a and the outer beam 218b allow a user to change the distance between the cross support beam 204 and the upper rear frame 14 of the bicycle 4. In other words, the telescoping relationship allows for selective positioning of the shelf 206 relative to the bicycle 4 as desired according to the individual bicycle 4 specifications and/or the needs of the user for proper positioning of the pack 135 (FIG. 2) on the shelf 206 when in use. The modular attachment of claim 10, where the shelf can position itself parallel to the rider to support the back of the rider when the user is not wearing a pack.

Referring to FIGS. 3 and 4, the shelf 206 is pivotably coupled to the apex 208 of the A-frame 210 to allow movement of the shelf 206 relative to the A-frame 210. For example, the shelf 206 is capable of moving relative to the apex 208 so that the shelf 206 translates forward or backward relative to the A-frame 210, or, in other words, closer to or further from the bicycle 4. The shelf 206 is further capable of moving relative to the apex 208 so that the shelf 206 tilts forward or backward relative to the A-frame 210, or, in other words, tilting so that a top surface 226 of the shelf 206 faces toward or away from the bicycle 4. For example, when the rider 136 (FIG. 2) does not utilize the shelf 206 for supporting the pack 135, the shelf 206 may pivot toward the bicycle 4 to form a backrest for the rider 136. The shelf 206 may be padded to better support and protect a pack 135 (FIG. 2) and its contents. For example, when the bicycle 4 is ridden over rough terrain, the padded shelf 206 may help mitigate damage during turbulence, friction, and/or force transferred to the pack 135 (FIG. 2), and, therefore, the rider 136 (FIG. 2).

The adjustable height of the legged support beams 202, the position of the legged support beams 202 along the lower rear frame 6, the adjustability of the angle and distance between the legged support beams 202, the adjustable length of the lateral support beam 218, and the maneuverability of the strap 230 and the shelf 206 allows the user to position the shelf 206 appropriately to best support the pack 135 (FIG. 2) to facilitate the carrying of the pack 135 by the rider 136 (FIG. 2). The adjustability of the pack support 200 further allows a single, modular design of the pack support 200 which is adjustable to appropriately attach to any bicycle 4 of differing sizes, shapes, brands, etc. and accommodate a variety of packs.

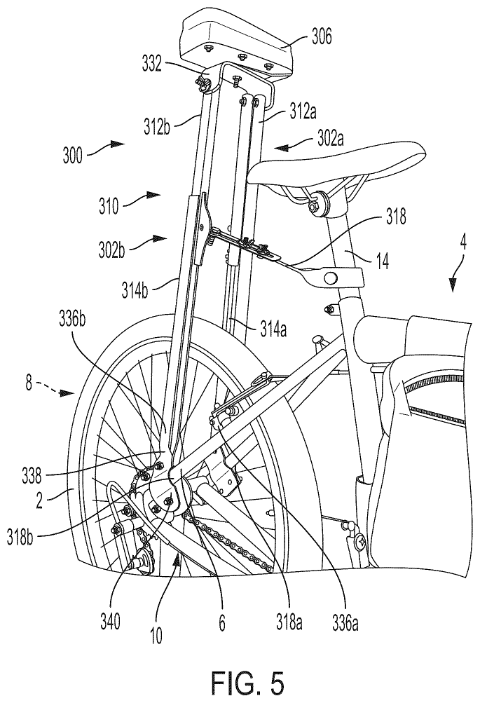

Now referring to FIG. 5, another embodiment of a pack support 300 is illustrated. The pack support 300 includes a frame 310 having a pair of legged support beams 302, a lateral support beam 318, and a shelf 306 coupled to the legged support beams 302 via a cap 332 of the frame 310. As discussed further herein, each of the legged support beams 302 include an inner beam 312 and an outer beam 314, wherein the inner beam 312 is received within the outer beam 314 to form a telescoping relationship so that the pack support 300 has an adjustable height. The inner beam 312 and outer beam 314 may each be formed in corresponding shapes, including an L-shape, a beam of a generally flat shape, a tubular shape having a rounded cross-section, a rectangular cross-section, or a cross-section of another suitable shape, or another suitable shape capable of the structure and function described further herein.

A first legged support beam 302a extends along a first side 8 of a back tire 2 of a bicycle 4 so that a lower portion 336a of the outer beam 314a is configured to couple to the lower rear frame 6 of the bicycle 4 at a first lower coupling point 318a as described further herein. A second legged support beam 302b extends along a second side 10 of the back tire 2 of the bicycle 4 so that a lower portion 336b of the outer beam 314b is configured to couple to the lower rear frame 6 of the bicycle 4 at a second lower coupling point 318b. The lower portions 336 of each corresponding outer beam 314 may be coupled to the lower rear frame 6 via a variety of mechanical fasteners and mounting components. For example, a collar similar to collar 220 (FIG. 3) may be used. In other embodiments, one or more of a plurality of brackets may be utilized, including twist brackets, such as twist bracket 338, frame brackets, such as frame bracket 340, bump brackets, tubular mounting brackets, ball and socket brackets, U-brackets, or a number of other brackets may be utilized. In some embodiments, the bracket(s) may have a durable non-slip lining, such as rubber or another friction polymer, to protect the lower rear frame 6 of the bicycle 4 and facilitate secure coupling of the legged support beams 302 to the lower rear frame 6 of the bicycle 4. Springs may also be utilized to allow for absorption of shock and corresponding movement of the legged support beams 302 during use. Such brackets and collars may be coupled to the bicycle 4 via adhesive, a built-in snapping mechanism (i.e. snapping into place), and/or any required number of mechanical fasteners, including quick release screws, set screws, hex screws, head bolts, machine screws, wing nuts, hexagon nuts, square nuts, hexagon nuts, or any other number of screws, bolts, and nuts suitable.

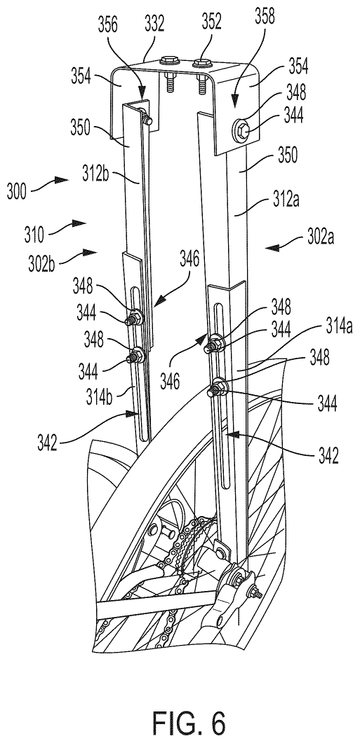

Referring additionally to FIG. 6, the telescoping function and relative structure of the legged support beams 302 is illustrated. As shown, each outer beam 314 defines an elongated aperture 342 configured to selectively receive at least one mechanical fastener 344 along its length. As illustrated, the elongated aperture 342 may receive at least two mechanical fasteners 344. In yet other embodiments, the elongated aperture 342 may receive a greater number of mechanical fasteners 344. The inner beam 312 includes corresponding aperture(s) 346 for receiving the mechanical fastener(s) 344 so the corresponding mechanical fastener(s) pass through each of elongated aperture 342 and corresponding inner beam aperture(s) 346 to couple the inner beam 312 with the outer beam 314.

A nut 348 of any variety discussed herein may be used with each mechanical fastener 344 to further strengthen the coupling between the inner beam 312 and the outer beam 314 so that movement of the inner beam 312 relative to the outer beam 314 is inhibited. In order to adjust the height of pack support 300 or otherwise allow movement of the inner beam 312 relative to the outer beam 314, the nut(s) 348 may be loosened relative to the corresponding mechanical fastener(s) 344 so that the mechanical fastener(s) 344 can move longitudinally within elongated aperture 342 and inner beam 312 can correspondingly move relative to outer beam 314. When the inner beam 312 is positioned as desired, the nut(s) 348 may be tightened relative to the corresponding mechanical fastener(s) 344 so that movement of the inner beam 312 relative to the outer beam 314 is inhibited. In other embodiments, other reversable fastening mechanisms may be utilized to selectively couple inner beam 312 to outer beam 314 while allowing the adjustability of the support pack 300 as discussed herein. For example, any combination of pins, clamps, quick release screws, detents, apertures, tabs, grooves, threading, or other removable fastening mechanisms may be considered.

Still referring to FIG. 6, the cap 332 is coupled to an upper portion 350 of each of the inner beams 312 of the legged support beams 302 using mechanical fasteners 344 as described further herein. As illustrated, the cap 332 may include a ledge portion 352 flanked by end extensions 354, where end extensions 354 extend away from the ledge portion 352 in a different plane than the ledge portion 352 so that each end extension 354 is capable of coupling with one of the legged support beams 302. For example, the upper portion 350 of each inner beam 312 may include an aperture 356 configured to receive a mechanical fastener 344 similar to the mechanical fastener(s) 344 described above. Each end extension 354 may have a corresponding aperture 358 that may be aligned with the aperture 356 of the corresponding inner beam 312 so that the mechanical fastener 344 may be received through the aperture 356 of the inner beam 312 and the aperture 358 of the corresponding end extension 356. Similar to the mechanical fastener(s) 344 described above, the coupling mechanism may further include a nut 348 to further strengthen the coupling between the cap 332 and the inner beams 312 and inhibit movement of the cap 332 relative to the inner beams 312. In other embodiments, the cap 332 may be coupled to the inner beam 312 using other methods, removable and permanent, including adhesive, welding, unitary manufacturing, or any combination of pins, clamps, quick release screws, detents, apertures, tabs, grooves, threading, or other fastening mechanisms.

With the utilization of removable fastening mechanisms, the angle of the cap 332 relative to the inner beams 312 may be adjusted to better fit the user's needs. In order to adjust the angle of the cap 332 or otherwise allow movement of the cap 332 relative to the inner beams 312, the nut(s) 348 may be loosened relative to the corresponding mechanical fastener(s) 344 so that the cap 332 may rotate about the axis of the mechanical fastener(s) 344 relative to the inner beams 312. When the cap 332 is positioned as desired, the nut(s) 348 may be tightened relative to the corresponding mechanical fastener(s) 344 so that movement of the cap 332 relative to the inner beam 312 is inhibited. In other embodiments, other reversable fastening mechanisms may be utilized to selectively couple cap 332 to the inner beams 312 as discussed above to facilitate selective positioning of the cap 332 relative to the inner beams 312. When coupled, the cap 332 forms a bridge between the inner beams 312 so that the ledge portion 352 may serve as a base for the shelf 306 as further described herein. A hook (not shown) may also be coupled to the cap 332 in some embodiments to allow for the attachment of an additional pack to the pack support 300 if desired.

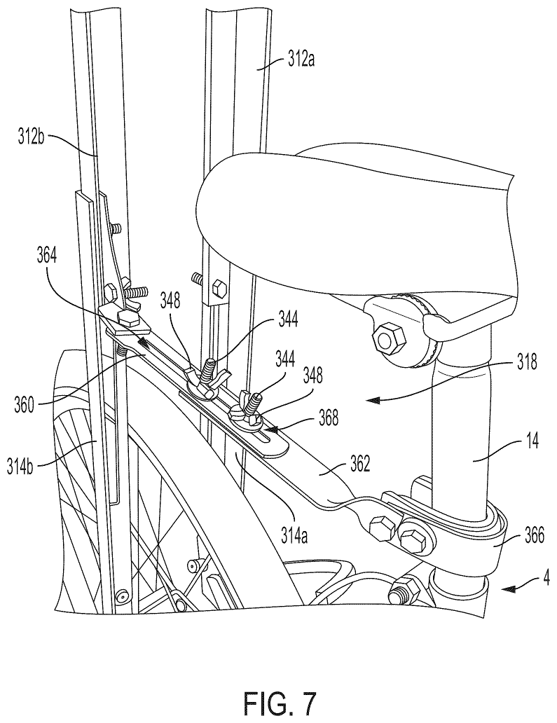

As shown in FIG. 7, the lateral support beam 318 is coupled to one of the inner beams 312. As illustrated, the lateral support beam 318 is coupled to a lower portion 358 of inner beam 312b. In other embodiments, the lateral support beam 318 may be coupled to inner beam 312a or both of inner beams 312, and/or may be coupled to either of the inner beams 312 at another position. The lateral support beam 318 may couple to the inner beam 312 via a variety of mechanical fasteners and mounting components. For example, one or more of a plurality of brackets may be utilized, including twist brackets, frame brackets, bump brackets, tubular mounting brackets, corner brackets, or a number of other brackets may be utilized. Such brackets may be couple the lateral support beam 318 with the corresponding inner beam 312 via any required number of mechanical fasteners, including clamps, quick release screws, set screws, hex screws, head bolts, machine screws, wing nuts, hexagon nuts, square nuts, hexagon nuts, or any other number of screws, bolts, and nuts suitable. Opposite the inner beam 312, the lateral support beam 318 couples to the upper rear frame 14 of the bicycle 4 via, for example, one or more a plurality of brackets as discussed above, e.g. U-bracket 366.

The lateral support beam 318 includes a positioning beam 360 and an anchoring beam 362 which form an adjustable relationship similar to the telescoping relationship of legged support beams 302. As illustrated, the positioning beam 360 couples with the inner beam 312, the anchoring beam 362 couples with the bicycle 4, and the positioning beam 360 and the anchoring beam 362 couple with each other at a selective position therebetween. The positioning beam 360 defines an elongated aperture 364 configured to selectively receive at least one mechanical fastener 344 along its length. As illustrated, the elongated aperture 364 may receive at least two mechanical fasteners 344. In yet other embodiments, the elongated aperture 364 may receive a greater number of mechanical fasteners 344. In yet other embodiments, the elongated aperture 364 may receive a greater number of mechanical fasteners 344. The anchoring beam 362 includes corresponding aperture(s) 368 for receiving the mechanical fastener(s) 344 so the corresponding mechanical fastener(s) pass through each of elongated aperture 364 and corresponding anchoring beam aperture(s) 368 to couple the positioning beam 360 with the anchoring beam 362.

A nut 348 of any variety discussed herein may be used with each mechanical fastener 344 to further strengthen the coupling between the positioning beam 360 and the anchoring beam 362 so that movement of the positioning beam 360 relative to the anchoring beam 362 is inhibited and/or vice versa. In order to adjust the distance between the pack support 300 and the upper rear frame 14 of the bicycle 4 or otherwise allow movement of the positioning beam 360 relative to the anchoring beam 362 or vice versa, the nut(s) 348 may be loosened relative to the corresponding mechanical fastener(s) 344 so that the mechanical fastener(s) 344 can move longitudinally within elongated aperture 342 and positioning beam 360 may correspondingly move relative to the anchoring beam 362 or vice versa. When the positioning beam 360 and the anchoring beam 362 are positioned as desired, the nut(s) 348 may be tightened relative to the corresponding mechanical fastener(s) 344 so that movement of the positioning beam 360 relative to the anchoring beam 362 is inhibited and vice versa. In other embodiments, other reversable fastening mechanisms may be utilized to selectively couple positioning beam 360 with anchoring beam 362 while allowing the adjustability of the support pack 300 as discussed herein. For example, any combination of pins, clamps, quick release screws, detents, apertures, tabs, grooves, threading, or other removable fastening mechanisms may be considered.

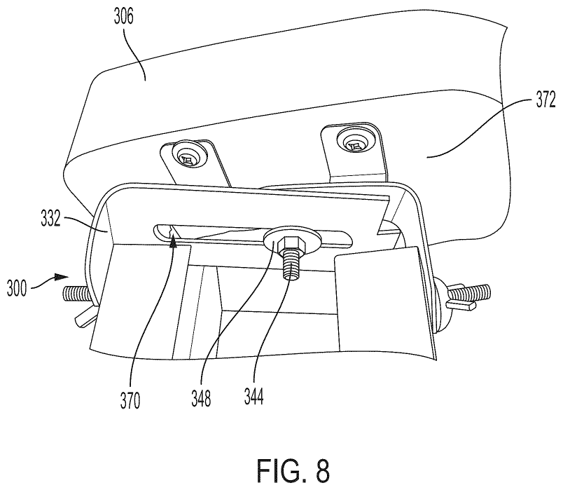

Now referring to FIG. 8, the shelf 306 of the pack support 300 and coupling of the shelf 306 with the cap 332 is illustrated. The cap 332 may include an elongated aperture 370 configured to receive a mechanical fastener 344 of the type further described herein, wherein the mechanical fastener 344 is embedded within a bottom surface 372 of the shelf 306. While one mechanical fastener 344 is illustrated, a greater number of mechanical fasteners may be utilized. Such an arrangement allows lateral adjustment of the shelf 306 relative to the cap 332 to allow for selective positioning of the shelf 306 as desired by the user. For example, similar to the adjustment mechanisms described above, a nut 348 of any variety discussed herein may be used with the mechanical fastener 344 to further strengthen the coupling between the shelf 306 and the cap 332 so that movement of the shelf 306 relative to the cap 332 is inhibited. In order to adjust the position of the shelf 306 relative to the cap 332 or otherwise allow movement of the shelf 306 relative to the cap 332, the nut 348 may be loosened relative to the corresponding mechanical fastener 344 so that the mechanical fastener 344 can move laterally within the elongated aperture 370 and the shelf 306 may move relative to the cap 332. When the shelf 306 is positioned as desired, the nut 348 may be tightened relative to the corresponding mechanical fastener 344 so that movement of the shelf 306 relative to the cap 332 is inhibited. In other embodiments, other reversable fastening mechanisms may be utilized to selectively couple the shelf 306 with the cap 332 while allowing the adjustability of the support pack 300 as discussed herein. For example, any combination of pins, clamps, quick release screws, detents, apertures, tabs, grooves, threading, or other removable fastening mechanisms may be considered. As with shelf 132, the shelf 306 may be padded to better support and protect a pack 135 (FIG. 2). For example, when the bicycle 4 is ridden over rough terrain, the padded shelf 132 may help mitigate damage to the pack 135 which could be caused by jostling or turbulence experienced by the bicycle 4 on such terrain.

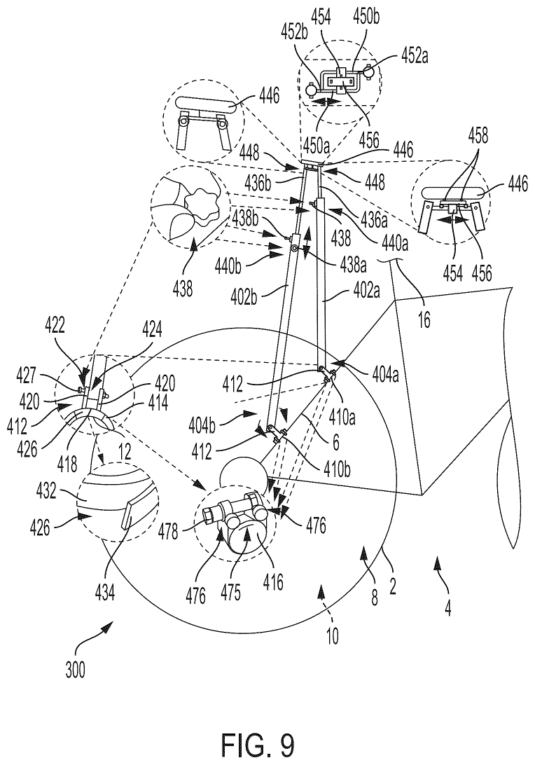

Referring now to FIG. 9, another embodiment of a pack support 400 is illustrated. The pack support 400 includes a pair of lower support beams 402, which may be configured to straddle a rear or back tire 2 of a bicycle 4 to form a triangle-type shape. A first lower support beam 402a may extend along a first side 8 of the back tire 2 so that a distal end 404a of the first lower support beam 402a may couple to the lower rear frame 6 of the bicycle 4 at a first lower coupling point 410a as described further herein. A second lower support beam 402b may extend along a second side 10 of the back tire 2 so that a distal end 404b of the second lower support beam 402b may couple to the lower rear frame 6 of the bicycle 4 at a second lower coupling point 410b as described further herein. As illustrated, when coupled to the lower rear frame 6, the first lower support beam 402a and the second lower support beam 402b may be skewed in relation to each other rather than generally parallel. In other words, the first lower coupling point 410a may be positioned closer to a seat 16 of the bicycle 4 than the second lower coupling point 410b. In some embodiments, the first lower support beam 402a may be shorter relative to the second lower support beam 402b to facilitate skewed coupling of the lower support beams 402 to the lower rear frame 6. This arrangement provides stability in the positioning and coupling of the pack support 400 without the need for a stability bar, for example, the lateral support beam 218 or the cross support beam 204 in FIG. 4.

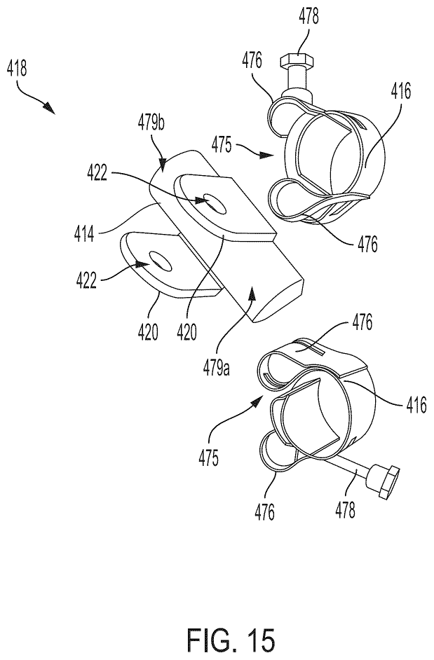

Each of the lower support beams 402 may be coupled to the rear frame 6 of the bicycle 4 via a coupling assembly 412. As seen in FIG. 15, the coupling assembly 412 may comprise an upper collar portion 414 and at least two hose clamps 416 to form a collar 418 configured to be positioned around the lower rear frame 6 of the bicycle 4 at coupling point 410. Two flanges 420 may be fixedly attached to the upper collar portion 414 for coupling the coupling assembly 412 to the corresponding lower support beam 402. The flanges 420 may be attached to the upper collar portion 414 via, for example, welding or single-piece construction. Each of the flanges 420 include a through hole 422 corresponding with a through hole 424 positioned at the distal end 404 of the corresponding lower support beam 402. A mechanical fastener 427, e.g., a bolt, may be received through each of the through holes 422, 424 when the through holes 422, 424 are aligned to couple the coupling assembly 412 to the corresponding lower support beam 402. The bolt-and-through-hole coupling mechanism allows the coupling assembly 412 to pivot relative to the corresponding lower support beam 402 to facilitate coupling of the lower support beam 402 to the lower rear frame 6.

A hose clamp 416 is positioned on either side of the flanges 420 at coupling points 479a and 479b. The hose clamps 416 are independent of the upper collar portion 414 and are used to couple upper collar 414 to the lower rear frame 6. The hose clamps 416 have a slit 475 that allows for the hose clamp 416 to be stretched and fitted around lower rear frame 6 then remember its cylindrical form once the hose clamp 416 encircles lower rear frame 6. It also has two looped flanges 476 that receive a pin 478. Pin 478 can be threaded through both flanges. When pin 478 is tightened, the slit 475 is narrowed or even closed, and hose clamp 416 is tightened around its circumference, locking into position upper collar 414 to lower rear frame 6.

As described above, the collar 418 may be positioned around the lower rear frame 6 of the bicycle 4 at coupling point 410 to couple the corresponding lower support beam 402 to the lower rear frame 6. A pad 426 may be positioned within the collar 418 to separate an inner surface 428 of the collar 418 from the surface 12 of the lower rear frame 6. The pad 426 may be formed of a cushion material 432, such as foam, and/or a friction material 434, such as rubber. The cushion material 432 and/or the friction material 434 allows for the tightening of the collar 418 on the lower rear frame 6 while mitigating or avoiding abrasive contact between the collar 418 and the lower rear frame 6 to prevent cosmetic and/or structural damage to the lower rear frame 6. The cushion material 432 may also help the collar accommodate a wider variety of shapes and sizes of lower rear frame 6. An embodiment of cushion material 432 could even use a heat molded substance so that cushion material 432 can mold to the shape of lower rear frame 6.

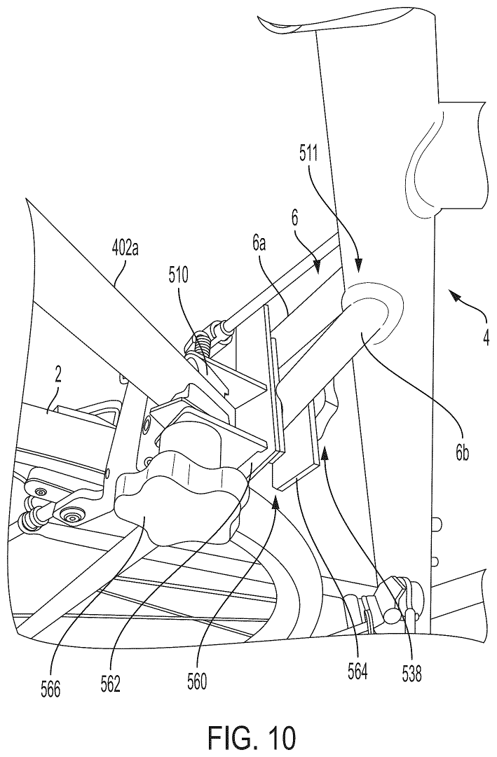

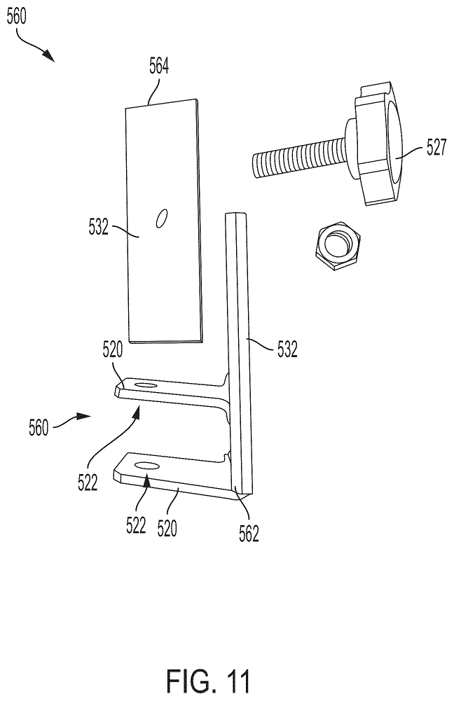

Referring now to FIGS. 10 and 11, an alternative embodiment of a collar that couples the lower support beam 402a to the lower rear frame 6 is depicted. Clamp 560 is positioned toward the seat 16 of bicycle 4 along lower rear frame 6. Lower rear frame 6 is made up of lower rear frame 6a and 6b. Lower rear frame 6a extends on one side of rear tire 2, while lower rear frame 6b extends on the other side of rear wheel 2. Lower rear frames 6a and 6b converge at point 511. Generally, clamp 560 is near convergence point 511. Clamp 560 is configured to receive both lower rear frame 6a and 6b. Clamp 560 includes top portion 562 and bottom portion 564. Clamp 560 includes a tightening assembly 527 to tighten top portion 562 and bottom portion 564 together so that the lower rear frames 6a and 6b are secured between top portion 562 and bottom portion 564 of clamp 560. Tightening assembly 527 may be, for example, a bolt, an Allen bolt, a thumb knob bolt, a cam handle bolt, or another bolt or mechanical fastener. The top portion 562 and bottom portion 564 may have a pad 532. The pad 532 may be formed of a cushion material, such as foam, and/or a friction material, such as rubber. The pad 532 and/or the friction material allows for the tightening of the clamp 560 on the lower rear frame 6 while mitigating or avoiding abrasive contact between the collar 418 and the lower rear frame 6 to prevent cosmetic and/or structural damage to the lower rear frame 6. The pad 532 may also help the collar accommodate a wider variety of shapes and sizes of lower rear frame 6. An embodiment of cushion material 532 may even use a heat molded substance so that cushion material 532 can mold to the exact shape of lower rear frame 6.

Top portion 562 includes bracket 566 that removably couples lower support beam 402a to clamp 560. Bracket 566 includes two flanges 520 that may be fixedly attached to the top portion 562. The flanges 520 may be attached to the top portion 562 by welding or single-piece construction. Each of the flanges 520 include a through hole 522 corresponding with a through hole 424 positioned at the distal end 404 of the corresponding lower support beam 402. A mechanical fastener 527, e.g., a bolt with a thumb knob and washer stopper, may be received through each of the through holes 522, 524 when the through holes 522, 524 are aligned to couple the bracket 566 to the corresponding lower support beam 402.

Further embodiments of clamp 560 may have a molded fit of top portion 562 and/or the bottom portion 564 that slightly bend around lower rear frame 6 rather than a flat bar, helping to prevent the rotation of top portion 562 and/or bottom portion 564 to pivot around the axis of the tightening assembly 527.

Referring back to FIG. 9, each of the lower support beams 402 is configured to receive a corresponding inner support beam 436 in a telescoping configuration. Each inner support beam 436 is configured to move within the corresponding lower support beams 402 and is capable of being locked into position relative to the corresponding lower support beam 402 with precision. For example, at least one tightening assembly 438 may be positioned at a proximal end 440 of each of the lower support beams 402. The tightening assembly 438 may be, for example, a bolt, an Allen bolt, a thumb knob bolt, a cam handle bolt, or another bolt or mechanical fastener configured to lock the inner support beam 436 into position relative to the corresponding lower support beam 402.

The tightening assembly 438 is configured to be actuated by a user to tighten against the inner support beam 436 against an inner surface of the lower support beam wall. In other words, as the tightening assembly 438 is tightened by the user, the inner support beam 436 is sandwiched between the tightening assembly 438 and the inner surface of the lower support beam wall to create enough friction between the tightening assembly 438, the inner support beam 436, and the lower support beam 402 to prevent movement of the inner support beam 436 relative to the lower support beam 402. Such an arrangement allows for the user to precisely position the inner support beam 436 relative to the lower support beam 402 as desired, rather than relying on preset positioning. In other embodiments, a detent or pin and hole arrangement as described above in relation to other embodiments or other positioning assemblies may be utilized. In yet another embodiment, the tightening assembly 538 includes at least one thumb knob pin that tightens against the inner support beam 436 to prevent movement relative to the lower support beam 402. As illustrated, each lower support beam 402 may include two tightening assemblies 438 to increase stability of inner support beam 436 position relative to the lower support beam 402. For example, a first tightening assembly 438a and a second tightening assembly 438b may be positioned about 90° apart around a perimeter of the corresponding lower support beam 402. In other embodiments, the first tightening assembly and the second tightening assembly may be positioned about 180° apart. In yet other embodiments, a greater number or lesser number of tightening assemblies may be utilized. In other embodiments, a cam handle bolt may be utilized around the top of lower support beam 402 with a slit along the length of lower support beam 402, the slit may be for example one inch long, a half inch long or another length. This slit facilities the squeezing of lower support beam 402 around inner support beam 436 so when the cam handle is tightened there is enough friction to precisely secure inner support beam 436 into position.

A shelf 446 is coupled to the proximal ends 448 of the inner support beams 436 as described further herein. The shelf 446 is positionable relative to the inner support beams 436 and the bicycle 4 so that a user may optimally position the shelf 446 to support a pack while using bicycle 4. A rail 450 is pivotably coupled to a proximal end 448 of each of the inner support beams 436 so that the rail 450 is configured to selectively pivot upward or downward as desired relative to the corresponding inner support beam 436 to position the shelf 446 as described further herein. A mechanical fastener, similar to tightening assembly 438 described above or another mechanical fastener, may lock the pivoting position of the rail 450 to its corresponding inner support beam 436, wherein loosening the mechanical fastener may allow for pivoting of the rail 450 relative to its corresponding inner support beam 436.

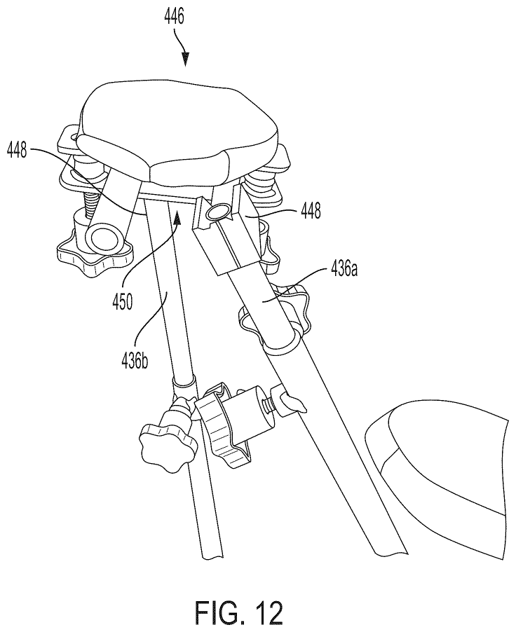

In FIG. 12, another embodiment of shelf 446 can be seen. Shelf 446 is sized and shaped to support a pack while using bicycle 4. The shelf 446 is connected to the rail clamp 454 as if the shelf 446, itself, was a bolt. In other words, shelf 446 screws onto the rail clamp 454 by rotating the shelf 446 clockwise. For this reason, the shelf 446 is circular but in other embodiments it could be a different shape, for example, an enlarged hexagon or other polygram. To help facilitate the shelf locking into position there is a rubber spacer between the underside of the shelf and the top side of the rail clamp 454. This rubber spacer also provides spacing between the shelf 446 and the rail clamp 454. Shelf 446 may be covered in padding or another soft material to mitigate damage to the pack from rough terrain and to improve the comfort of the rider 136.

As illustrated in FIG. 9, the rail 450a extends from its corresponding inner support beam 436 toward the other inner support beam 436b, curving toward the other rail 450b to generally form an L-shape. Similarly, the rail 450b extends from its corresponding inner support beam 436 toward the other inner support beam 436a, curving toward the other rail 450a to generally form an L-shape. The ends 452 of each respective rail 450 rests on the other rail 450. In other words, end 452a of rail 450a rests upon rail 450b, while end 452b of rail 450b rests upon rail 450a. Such arrangement allows for each rail 450 to maintain a level and parallel arrangement relative to the other rail 450 while simultaneously allowing for the raising and lowering of each inner support beam 436 relative to the other inner support beam 436 to facilitate tilting of the shelf 446 forward or backward relative to the bicycle 4 as desired by the user and/or while simultaneously allowing movement of each of the inner support beams 436 toward or away from the other of the inner support beam 436 via a lateral sliding relationship between the rails 450 to facilitate proper fitting and coupling of the pack support 400 to the lower rear frame 6 of the bicycle 4 as described above. In other embodiments, the rails 450 may be substituted for a single cylindrical, cubical, or another shaped beam, or beams that form a telescoping relationship similar to the ones already described, that which links, on the same apex, inner support beams 436.

A rail clamp 454 couples the rail 450a with the rail 450b to maintain a constant distance between the rails 450. The rail clamp 454 has a sliding relationship with each of the rails 450 so that the rails may slide laterally as discussed above, i.e., so that the inner support beams 436 may move closer to and further from the other of the inner support beams 436. The rail clamp 454 may include a mechanical fastener, similar to the tightening assembly 438 as described above, or another mechanical fastener, to lock the rail clamp 454 in position relative to the rails 450, wherein loosening of the mechanical fastener may re-establish the sliding relationship between the rail clamp454 and the rails 450. As illustrated in FIG. 9, a connector 456 is coupled to the rail clamp 454 to form a t-shape. The connector 456 may be fixedly coupled to the rail clamp 454 via, for example, welding or single piece construction. The shelf 446 may then be coupled to the connector 456, which may be secured to the shelf 446 via mechanical fasteners, such as bolts 458. In other embodiments, the shelf 446 may be fixedly coupled to the connector 456 via, for example, adhesive or welding. In yet other embodiments, the shelf 446 may be coupled directly to the cross-rail 454. For example, one way the shelf 446 may be coupled directly to the rail clamp 454 is by making the shelf 446 itself the fastening mechanism, thus serving as two functions, clamping the rail clamp 454 and securing the shelf 446. In other words, the shelf 446 may have a circular shape with a short-threaded protruding pole on the underside that can be rotated into the rail clamp 454, clamping rail clamping 454 and securing shelf 446.

Tilting of the shelf 446 may be accomplished via raising and lowering of the inner support beams 436 relative to the corresponding lower support beams 402 and the pivotable relationship between the inner support beams 436 and the corresponding rails 450. Tilting of the shelf 446 may also be accomplished via the coupling relationship between the lower support beams 402 and the lower rear frame 6 of the bicycle 4, wherein the positioning of the lower support beams 402 relative to the lower rear frame 6 may result in an offset relationship between the inner support beams 436. In either of these scenarios, the relationship between the rails 450, wherein the ends 452 of each rail 450 rests upon the other rail 450, maintains a level and parallel relationship between the rails 450, which is further facilitated by the cross-rail 454. As such, the shelf 446 may be tilted while maintaining a generally straight surface on which the pack may rest.

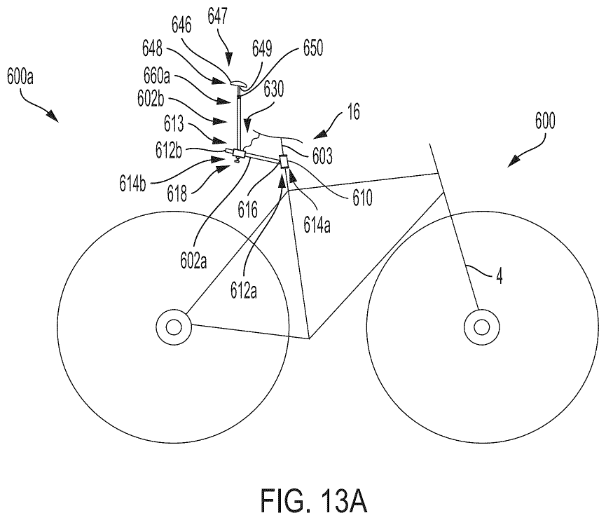

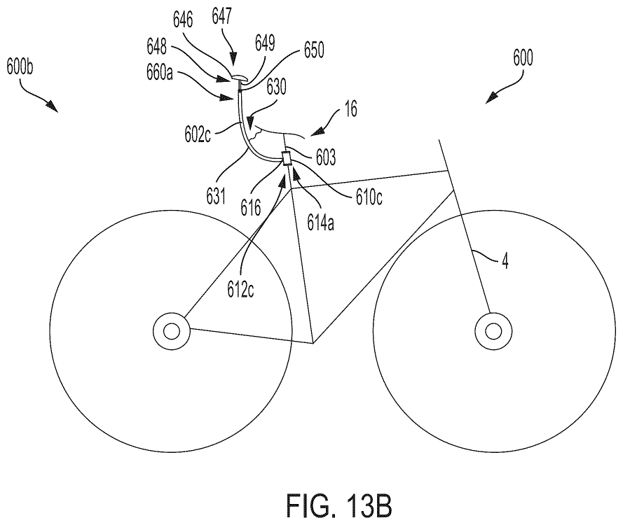

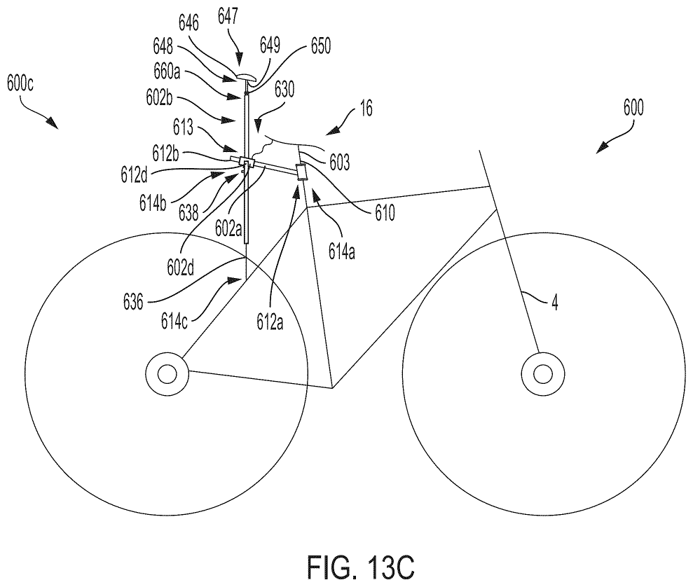

Referring now to FIG. 13a, another embodiment of a pack support 600 is illustrated. The pack support 600a includes a pair of support beams 602a, 602b that is approximately vertical and a horizontal support beam 602a that is approximately horizontal. The horizontal support beam 602a extends approximately perpendicularly at a coupling point 610 from a bike seat pole 603 and the vertical support beam 602b extends approximately perpendicular to horizontal support beam 602a. The horizontal support beam 602a is a cantilever that transfers the loads from the shelf 646, down the vertical support beam 602b, through the cantilever of horizontal support beam 602a, and to the support of bike seat pole 603 where it applies a sheer test and bending movement. To accommodate and distribute the sheer test and bending movement at coupling point 610 there is a rail collar 612 that can be, for example, 1 inch, 1.5 inches, 2 inches, 2.5 inches or any other length that sufficiently secures pack support 600a. In other embodiments, coupling point 610 may be a permanent attachment point for the horizontal support beam 602a and bike seat pole 603, thus making horizontal support beam 602a and bike seat pole 603 one unit. This rail collar 612a, which can be fixed with the horizontal support beam 602a via a weld or another form, is coupled to the bike 4 by removing bike seat pole 603, sliding on the rail collar 612a and then reinstalling bike seat pole 603 to bike 4 with the rail collar 612a attached. At the distal end of horizontal support beam 602a, a coupling assembly 612b is removably coupled, as described further herein. A vertical support beam 602b may extend from a point 613 along horizontal support beam 602a, coupling to horizontal support beam 602a with coupling assembly 612b, as described further herein. As illustrated, when coupled together, horizontal support beam 602a and vertical support beam 602b make a skewed L-shape. Horizontal support beam 602a may not be exactly perpendicular to bike seat pole 603 and may angle up so that the forces of downward load have a more direct path to the bike, it also angles up to reduce the weight and materials needed, and so it is more ergonomic in approximal relation to the angle of the back of the rider. In an embodiment of pack support 600 a flexible strap 630 may be added to further support the load of shelf 646 that connects coupling assembly 612b to a bicycle seat 16. If utilized, this strap 630 alleviates the sheer test and bending movement at coupling point 610 of the rail collar 612, which would otherwise be the only coupling point to bike 4. Strap 630 is similar to strap 230, previously described, and could be made from textiles, polymers, metals, or a combination of different materials. For example, it could be a rope, Velcro, a cable, or it could even be a ridged or semi-ridged metal strap or beam. One way strap 630 is different to strap 230, previously described, is they couple to bike 4 in a different area, rather than coupling to the bike seat pole 603, strap 630 couples under bicycle seat 16 by either wrapping around the bicycle seat 16 rails or by connecting directly to the bicycle seat 16 rails.

Horizontal support beam 602a couples to the bike seat pole 603 of the bicycle 4 via a coupling assembly 612a. The coupling assembly 612a may comprise a collar 614a that includes hose clamps 416 that removably couple the horizontal support beam 602a to the bike seat pole 603. Bicycle seat rail clamp 616 lock into place with a thumb knob, or other mechanical tightening assembly. Similarly, vertical support beam 602b couples to the distal end of horizontal support beam with coupling assembly 612b. Coupling assembly 612b may comprise a collar 614b that includes a tightening assembly 618. Tightening assembly 618 includes a thumb knob that locks vertical support beam 602b into place.

In one embodiment, horizontal support beam 602a and vertical support beam 602b can be configured to having a sliding relationship at coupling point 613. Coupling assembly 612b, when in a non-tightened state, can slide along horizontal support beam 602a in order to adjust the position of vertical support beam 602b in relation to a rider on seat 16. Tightening assembly 618 is used to lock the position of vertical support beam 602b in relation to horizontal support beam 602a so that further sliding along horizontal support beam 602a is prevented.

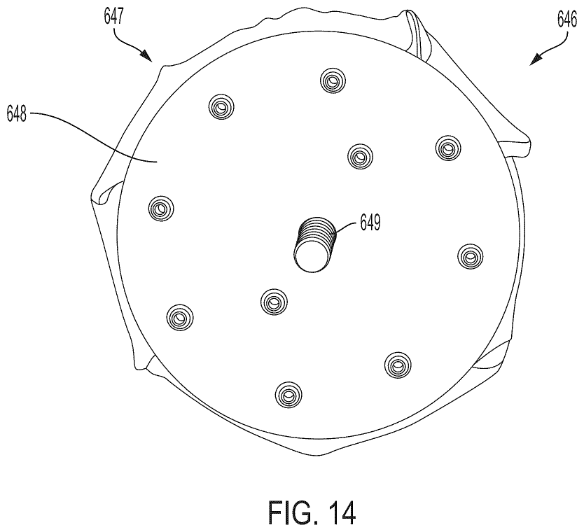

Shelf 646 is coupled to the distal end of vertical support beam 602b. Shelf 646 includes a first side 647 with a cushion or other soft surface, and a second side 648 that has a threaded bolt 649, as best seen in FIG. 14, positioned to support the seat. Vertical support beam 602b has a threaded opening 660a with internal threads that are configured to receive threaded bolt 649. Shelf 646 can be adjusted up and down by threading threaded bolt 649 more or less into vertical support beam 602b. Once shelf 646 is positioned to a determined height, a lock nut 650 can be tightened to prevent shelf 646 from being threaded up or down.

A second embodiment of pack support 600 can be seen in FIG. 13b. Notably, pack support 600b has a curved support beam 602c instead of a horizontal and vertical support beam 602a and 602b, as seen in pack support 600a. Curved support beam 602c has one coupling point 610c to bike seat pole 603 using a rail collar 612c similar to rail collar 612a, as described above, and is shaped to curve upward in a L-like fashion so that a shelf can be supported at the distal end of curved support beam 602c. Curved support beam 602c includes a threaded opening 660b that receives the threaded bolt 649 of shelf 646 and lock nut 650, as described above in reference to pack support 600a. Further, pack support 600 could include a flexible strap 630 that connect to a point 631 along curved support beam 602c and extends to seat 16 of bicycle 4, this second coupling point with strap 630 is added to support the cantilever-like-design of curved support beam 602c.

Referring now to FIG. 13c, a third embodiment of pack support 600 is described. Pack support 600c is similar to pack support 600b. Pack support 600c includes a lower support beam 602d that extends from coupling point 613. Lower support beam 602d couples to lower rear frame 6 at point 614. A collar 612d is positioned at coupling point 613 to removably couple lower support beam 602d to lower rear frame 6. Collar 612d can be a rail collar similar to rail collar 612a or another mechanical fastener already known in the art. Lower support beam 602d can also be fixedly coupled to lower rear frame 6 via welding or other fixed fastening measures.

Lower support beam 602d can be configured to receive a corresponding inner support beam 636 in a telescoping configuration. Inner support beam 636 is configured to move within lower support beam 602d and is capable of being locked into position relative to the corresponding lower support beam 602d with precision. For example, at least one tightening assembly 638 may be positioned at an end of lower support beam 602d. The tightening assembly 638 may be, for example, a thumb knob bolt, a cam handle bolt, or another bolt or mechanical fastener configured to lock the inner support beam 636 into position relative to the corresponding lower support beam 602d.

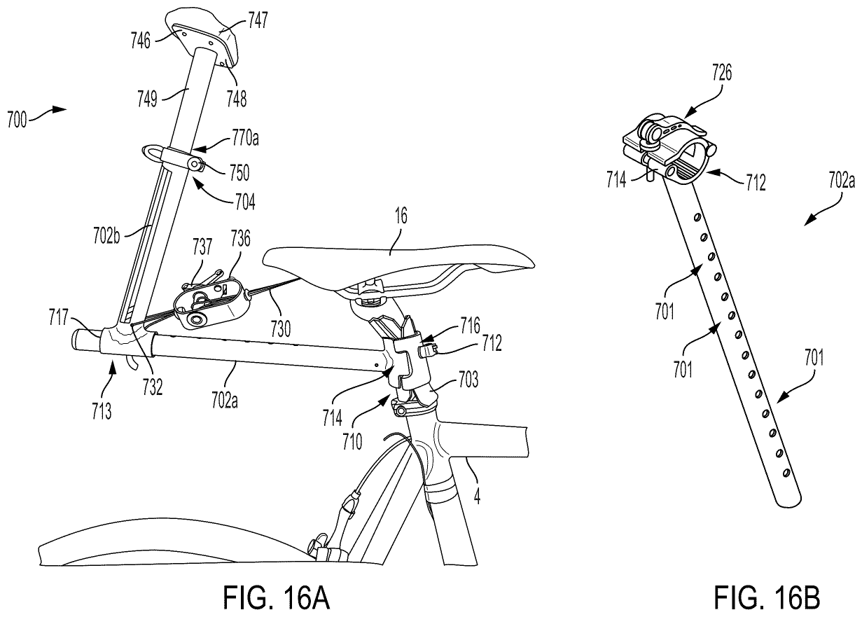

Referring now to FIGS. 16a and 16b, another embodiment of a pack support 700 is illustrated. The pack support 700 includes a vertical support beam 702a, and a horizontal utility pole 702b.

As illustrated, utility pole 702a extends approximately perpendicularly at a coupling point 710 from a bike seat pole 703 and the vertical support beam 702b extends approximately perpendicular to utility pole 702a. The utility pole 702a is a cantilever that transfers the loads from the shelf 746, down the vertical support beam 702b, through the cantilever of utility pole 702a, and to the support of bike seat pole 703 where it applies a sheer test and bending movement. To accommodate and distribute the sheer test and bending movement at coupling point 710, utility pole 702a is removably coupled to bike seat pole 703 by a rail collar clamp 712. Pack support 700 may be attached to bike 4 without removal of bike seat pole 703. Rail collar clamp 712, which can be fixed with the utility pole 702a via a weld or another form, may comprise a collar 714 that includes a clamp 716 that removably couples the utility pole 702a to the bike seat pole 703. Rail collar clamp 712 may lock into place with a thumb knob, cam clamp, or other mechanical tightening assembly. Alternatively, in another embodiment, utility pole 702a may be permanently coupled to bike seat pole 703 by welding or other methods.

Along the length of utility pole 702a are a plurality of holes 701, as illustrated in FIG. 16b. The plurality of holes 701 allow for attachment of vertical support beam 702b to utility pole 702a. Vertical support beam 702b may extend from a point 713 along utility pole 702a by a coupling assembly 717. Coupling assembly 717 may be a ball lock pin or other fastener such as a plunger lock pin, eye end fitting, or retaining clip, that extends through any one of the plurality of holes 701 into a through hole in a proximal end 703 of vertical support beam 702b. Due to the plurality of holes 701 in utility pole 702a, vertical support beam 702b may be coupled along utility pole 702a in various distances from rail collar clamp 712a.

Referring again to FIG. 16a, when coupled together, utility pole 702a and vertical support beam 702b make a skewed L-shape. Utility pole 702a may not be exactly perpendicular to bike seat pole 703 and may angle up so that the forces of downward load have a more direct path to the bike, it also angles up to reduce the weight and materials needed. Utility pole 702a may also angle up for a more ergonomic fit approximately parallel to the angel of the back of the rider.

Shelf 746 is coupled to the distal end 704 of vertical support beam 702b. Shelf 746 includes a first side 747 with a cushion or other soft surface, and a second side 748 that has a shelf pole 749 positioned to support the seat and extend vertically downward from section side 748. First side 747 may be a thick cushion material to accommodate different angles of the bag on fixed angled shelf 746. Vertical support beam 702b can have an opening 770a shaped to receive shelf pole 749 in a telescopic manner. Shelf pole 749 can slide into vertical support beam 702b and may be locked into place with a cam clamp 750. Shelf 746 can be adjusted up and down by inserting and removing shelf pole 749 various depths into vertical support beam 702b. Once shelf 746 is positioned to a determined height, cam clamp 750 can be closed to lcok shelf 746 into position within vertical support beam 702b.

In the case that pack support 700 is supporting a heavy load, a cable 730 and winch 736 may be used to add further support to utility pole 702a and vertical support beam 702b, for example, by acting as a gusset. If utilized, cable 730 and winch 736 alleviate the sheer test and bending movement at coupling point 710 of the rail collar 712, which would otherwise be the only coupling point to bike 4. Further, winch 736 and cable 730 may also be used to support any accessories attached to pack support 700. In another embodiment, a metallic split key ring may be inserted through hole 732 to allow cable 730 to pass through the split key ring rather than though hole 732. Ends 731a and 731b of cable 730 pass through a hole 732 in vertical support beam 702b and wrap around seat 16 of bike 4. Ends 731a and 731b enter winch 736 and wrap around winch turn 737. As winch turn 737 is rotated, cable 730 is tightened such that cable 730 becomes a second coupling point to bike 4 and adds further support to pack support 700. The winch and cable may be configured to support other desired accessories, if desired. In another embodiment, winch 736 may be embedded into the base of vertical support beam 702b.

In addition to allowing a myriad of positions along utility pole 702a that vertical support beam 702b may be coupled to, the plurality of holes 701 allow other accessories to be coupled to utility pole 702a. For example, a flagpole, light, reflective object, child seat, pet carrier, rain fender, various types of racks, various types of hangers, or other niche carriers and/or accessories and/or attachments tailored to the user's preferences may be coupled to at least one of the plurality of holes 701. Accessories can be used independently as well as simultaneously with vertical support beam 702b. For example, vertical support beam 702b may be used along with a flagpole and a rack.

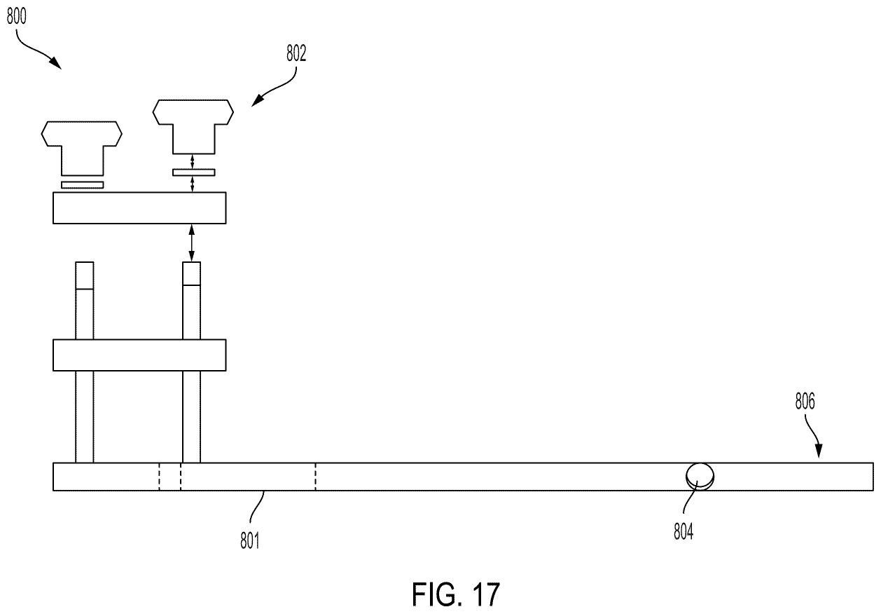

In one embodiment as seen in FIGS. 17-19, a rack 800 may coupled to the underside of utility pole 702a to support additional baggage such as a pannier bag, saddle bags, truck top bags, crates, boxes, or other luggage. Rack 800 and vertical support beam 702b may be simultaneously coupled to utility pole 702a. Rack 800 comprises an L-shaped support bar 801, a support platform 806, and curved side supports 807. L-shaped support bar 801 couples to utility pole 702a using at least one tightening assembly 802. The at least one tightening assembly 802 may be, for example, a bolt, an Allen bolt, a thumb knob bolt, a cam handle bolt, c-shaped retaining rings, snap ring, or another bolt or mechanical fastener. The at least one tightening assembly 802 passes though at least one of the plurality of holes 701 into the proximal end 803 support bar 801 and can be tightened, snapped, or clipped by a user.

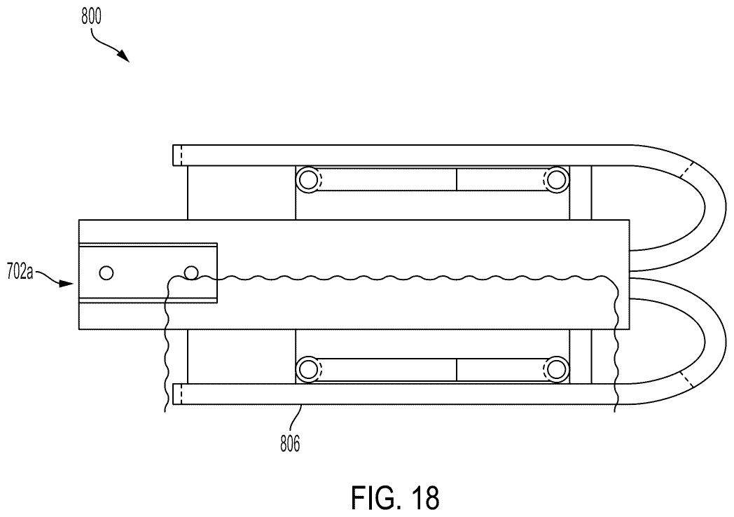

As seen in FIG. 18, the distal end 804 of support bar 801, a support platform 806 is formed. Support platform 806 can be rectangular, square, or any shape optimized to support additional baggage. Support platform 806 may have a B-shape at the end of the platform. Baggage can hang, rest, slide on, or in any other way be removably placed on support platform 806.

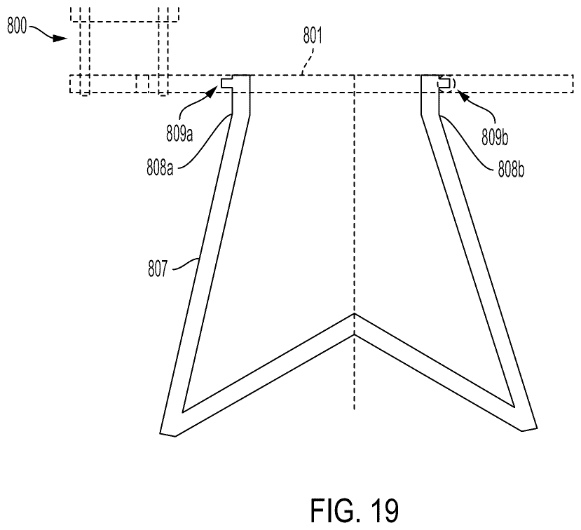

Curved side supports 807 may be removably coupled to support bar 801 on either side of support bar 801 via knobs 809a, 809b in the distal ends 808a, 808b of curved side supports 807, as further illustrated in FIG. 19. Curved side support 807 locks into place like a spring, pressing knobs 809a, 809b into windows at each corresponding side of support bar 801. In one embodiment, curved side support 807 may attach to support bar 801 via Allen bolts or other fasteners. Curved side support 807 may extend below support bar 801 for a distance and then curve back up to support bar 801 such that curved side supports 807 connect to support bar 801 at its two distal ends 808a, 808b. Curved side supports 807 may be configured to prevent a bag supported by support platform 806 from touching a wheel on bike 4.

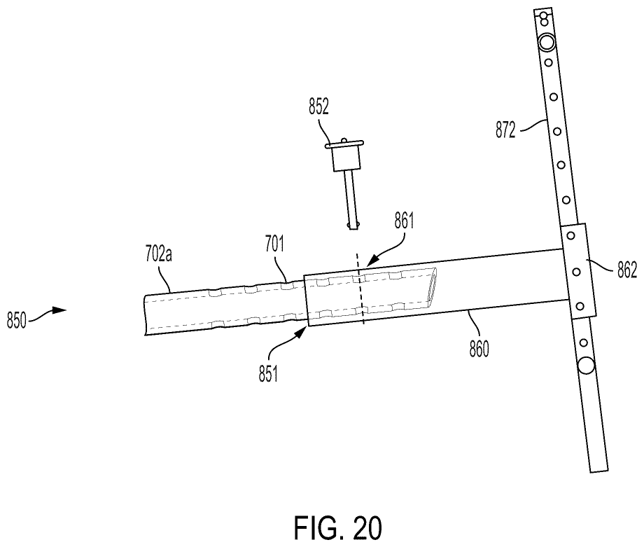

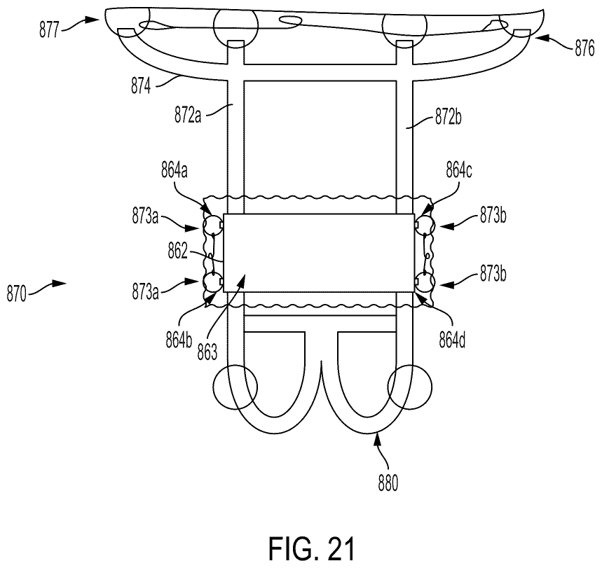

In another embodiment as seen in FIGS. 20-21, a hanger 850 may be coupled to utility pole 702a. Hanger 850 comprises a hanger pole 860. Hanger pole 860 has a plurality of openings 861 along the length of the hanger pole 860. Hanger pole 860 can have an opening 851 shaped to receive utility pole 702a in a telescopic manner. Utility pole 702a can slide into opening 851 of hanger pole 860 and may be locked into place by passing ball lock pin 852 or other fastener through at least one of the plurality of openings 861 in hanger pole 860 into one of the plurality of holes 701 along utility pole 702a. The plurality of holes 701 and plurality of openings 861 allow for various positions of the hanger pole 860. Hanger 850 may be adjusted relative to shelf support 700 by matching up various holes 701 and openings 861. Hanger 850 and vertical support beam 702b may be simultaneously coupled to utility pole 702a.

At the distal end of hanger pole 860, back support surface 862 is coupled by welding or other permanent methods such that a flat face 863 of back support surface 862 is in a plane perpendicular to the direction of utility pole 702a and hanger pole 860. Back support surface 862 has four through holes 864a, 864b, 864c, 864d spaced apart on the perimeter of back support surface 862. Each hole 864a, 864b, 864c, 864d is configured to receive a ball lock pin.

As seen in FIG. 21, hanger 850 further comprises a hanger assembly 870. Hanger assembly 870 comprises two vertical support beams 872a, 872b and a horizontal rack 874. Vertical support beams 872a, 872b are spaced apart by a width that is equal to a width of the back support surface 862. Vertical support beams 872a and 872b are connected at their distal end by horizontal rack 874. Horizontal rack 874 extends the width between vertical beams 872a, 872b and may contain multiple prongs 876 that extend vertically from horizontal rack 874. Hanger assembly 870 is configured to allow a user to hang straps of a bag, pack or other storage container, such as a baby carrier or dog carrier, across horizontal rack 874 such that the straps of the bag are retained on horizontal rack 874 by prongs 876. In another embodiment, a safety wire 877 is looped through prongs 876 to retain a bag supported by horizontal rack 874. When a bag is hanging on horizontal rack 874, the bag may be supported by the back support surface 862 so that the bag does not swing into a rider while using hanger 850 attached to pack support 700. In another embodiment, safety wife 877 may be a cable, bungee, rope, or other string used in conjunction with a plurality of split key rings arranged around horizontal rack 874 to further secure the bag.

Additionally, in some embodiments, a B-shaped pole 880 may extend from the proximal end of the vertical support beams 872a, 872b such that the curves of the B-shaped pole straddle the tire of bike 4.

A plurality of holes 873a, 873b extend the length of vertical support beams 872a and 872b and are configured to receive a ball lock pin or other fastener, such as an eye end fastener, split key rings, cotter pins, R-clips, or retaining clips. Hanger assembly 870 may be installed onto back support surface 862 by placing vertical support beams 872a and 872b on either side of back support surface 862 and coupling vertical support beams 872a and 872b to back support surface 862 at connection points 875a, 875b, 875c, and 875d by ball lock pins or other fasteners, such as an eye end fastener, split key rings, cotter pins, R-clips, or retaining clips that extend through the plurality of holes 873a, 873b into the four through holes 864a, 864b, 864c, 864d on the back support surface 862. The plurality of holes 873a, 873b along the vertical support beams 872a, 872b allow for various positions of the hanger assembly 870. Hanger assembly 870 may be adjusted up and down relative to back support surface 862 by matching up various holes in the plurality of holes 873a, 873b to the four holes 864a, 864b, 864c, 864d in the back support surface 862. The adjustability of hanger 870 allows for accommodation of various styes of bikes and packs.

The components as described herein in relation to pack support 100, pack support 200, pack support 300, pack support 400, pack support 600, and pack support 700 are preferably comprised of a strong, yet lightweight, material. For example, some or all of the components of the pack support 100, pack support 200, pack support 300, pack support 400, pack support 600, and/or pack support 700 may be comprised of aluminum, an aluminum alloy, a polymer, or carbon fiber. In other embodiments, the pack support 100, pack support 200, pack support 300, pack support 400, pack support 600, and pack support 700 may be comprised of another metallic material, e.g., steel or a steel alloy. In some embodiments, some, most, or all of the material used may be formed of recycled materials. When the shelf 132, 206, 306, 446, 646, and 746 of corresponding pack support 100, 200, 300, 400, 600, and 700 respectively, is positioned properly, the pack support 100, 200, 300, 400, 600, and 700 is configured to support at least a portion of the weight of the pack 135 (FIG. 2). For example, the pack support 100, 200, 300, 400, 600, and 700 may be configured to support at least 30%, at least 40%, at least 50%, at least 60%, at least 70%, at least 75%, at least 80%, at least 85%, or more of the pack. When positioned appropriately, the pack support 100, 200, 300, 400, 600, and 700 is configured to support a majority of the weight of the pack 135. In this way, when a rider of bicycle 4 is wearing or otherwise carrying pack 135, the pack support 100, 200, 300, 400, 600, and 700 may relieve the rider of some of the weight of the pack, thereby facilitating easier travel with the pack 135, allowing the rider to operate the bicycle 4 more efficiently over longer distances with the pack 135, etc. Moreover, accessories increase the functionality of pack support 700 so that other needs of the rider of bicycle 4 may be met.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A bicycle attachment, the bicycle attachment comprising:
a support system, comprising:
at least two support beams; and
a shelf pivotably supported by the at least two support beams.

2. The bicycle attachment of claim 1, wherein the at least two support beams includes a first lower support beam and a second lower support beam coupled to the first lower support beam.

3. The bicycle attachment of claim 2, wherein the first lower support beam and second lower support beam are coupled to a lower rear frame of a bicycle so that the first and second lower support beams straddle a rear tire of the bicycle to form a triangle shape defining an apex.

4. The bicycle attachment of claim 3, wherein the shelf is positioned above the apex.

5. The bicycle attachment of claim 3, wherein the first lower support beam and the second lower support beam are skewed in relation to each other so that the first lower support beam couples to the lower rear frame closer to a bicycle seat and the second lower support beam couples to the lower rear frame closer to the rear tire of the bicycle.

6. The bicycle attachment of claim 3, wherein the lower rear frame of the bicycle includes a first lower rear frame and a second lower rear frame, the first lower rear frame and the second lower rear frame extending from a convergence point near a bicycle seat toward the rear tire; wherein the first lower rear frame extends on one side of the rear tire and the second lower rear frame extends on the other side of the rear tire.

7. The bicycle attachment of claim 6, wherein the first lower support beam is coupled to the lower rear frame with a collar, the collar configured to removably clamp both the first lower rear frame and the second lower rear frame close to the convergence point of the first lower rear frame and the second lower rear frame.

8. The bicycle attachment of claim 1, wherein the at least two lower support beams are configured to receive a corresponding inner support beam in a telescoping configuration so that the inner support beam moves within the corresponding at least two lower support beams, making a height of the lower support beams adjustable.

9. A modular attachment for supporting a pack, the modular attachment comprising;
a rail;
a first lower support beam coupled to the rail;
a second lower support beam coupled to the rail opposite the first lower support beam;
a shelf coupled to the rail.

10. The modular attachment of claim 9, wherein the rail is configured to pivot upward or downward to position the shelf.

11. The modular attachment of claim 9, wherein the rail further includes a first rail that corresponds with the first lower support beam and a second rail that corresponds with the second lower support beam.

12. The modular attachment of claim 11, wherein the first rail further includes a mechanical fastener to lock a pivoting position of the first rail relative to the first lower support beam and the second rail further includes a mechanical fastener to lock a pivoting position of the second rail relative to the second lower support beam.

13. The modular attachment of claim 11, wherein the first rail extends from its corresponding first lower support beam curving toward the second rail to from an L-shape and the second rail extends from its corresponding second lower support beam curving toward the first rail to from an L-shape.

14. The modular attachment of claim 11, further comprising a cross rail that couples to the first rail and the second rail so that a constant distance is maintained between the first rail and the second rail.

15. The modular attachment of claim 14, wherein the cross rail has a sliding relationship with the first rail and the second rail so that the first rail and the second rail may slide laterally.

16. A modular attachment for supporting a pack, the modular attachment comprising:
a first lower support beam;
a second lower support beam movably coupled to the first lower support beam so that an angle is defined therebetween, the first lower support beam and the second lower support beam defining a triangular shape with an apex; and
a shelf pivotably coupled to the apex.

17. The modular attachment of claim 16, the first lower support beam further comprises a first inner beam and a first outer beam;
wherein the first inner beam and the first outer beam defining a telescoping relationship so that a height of the first lower support beam is adjustable; and
wherein the first lower support beam is coupled to a lower rear frame of a bicycle.

18. The modular attachment of claim 17, the second lower support beam further comprises a second inner beam and a second outer beam;
wherein the second inner beam and the second outer beam defining a telescoping relationship so that a height of the second lower support beam is adjustable; and
wherein the second lower support beam is coupled to the lower rear frame of the bicycle.

19. The modular attachment of claim 18, wherein the shelf is configured to tilt by raising and lowering the first inner support beam and the second inner support beam.

20. The modular attachment of claim 18, wherein the shelf is configured to tilt by positioning the first lower support beam and the second lower support beam relative to the lower rear frame of the bicycle.
